(19) United States
(12) Patent Application Publication
(10) Pub. No.: US 2023/0365252 A1
(43) Pub. Date: Nov. 16, 2023

(54) SET OF DOORS FOR AN AIRCRAFT FRONT LANDING GEAR BAY COMPRISING FRONT DOORS FITTED WITH DEFLECTORS

(71) Applicant: Airbus Operations (S.A.S.), Toulouse (FR)

(72) Inventor: Jérôme Antypas, Toulouse (FR)

(21) Appl. No.: 18/317,207

(22) Filed: May 15, 2023

(30) Foreign Application Priority Data
May 16, 2022 (FR) 2204599

(51) Int. Cl. B64C 25/16

(52) U.S. Cl. CPC B64C 25/16

(57) ABSTRACT

A set of doors includes two front doors and two rear doors to open or close the front landing gear bay of the aircraft to enable lowering or retraction of a landing gear, each of the front doors including at least one deflector arranged on an internal face of the front door near a rear leading edge thereof, the deflector extending along the rear leading edge, the set therefore enabling action on an aerodynamic flow between the front doors to disturb it in such a manner as significantly to attenuate undesirable transitory vibratory phenomena that can arise in a particular configuration in which the front doors are open and the rear doors are closed.

### TECHNICAL FIELD

The disclosure herein concerns a set of doors for a front landing gear bay of an aircraft, a front landing gear bay including such a set of doors, and an aircraft including such a front landing gear bay.

### BACKGROUND

As is known, an aircraft, in particular a transport aircraft, rolls on the ground by front and rear landing gear retractable into the fuselage of the aircraft. In particular, the front landing gear can be folded into a front landing gear bay when the aircraft is in flight. To this end the front landing gear bay includes a set of doors configured to open or close it in order to enable lowering or retraction of the front landing gear.

In some aircraft the front landing gear bay includes four doors, two so-called front doors situated toward the nose of the aircraft and two so-called rear doors situated just behind the front doors. These front and rear doors are generally designed so that during take-off or landing the pair of front doors and the pair of rear doors open or close one after the other. Also, there is a time interval, generally of a few seconds, during which the front doors are open while the rear doors are closed.

This particular configuration can generate a vibratory phenomenon at the level of the front landing gear bay at around 20 Hz. This vibratory phenomenon, although transitory because occurring only during a short time interval, can cause discomfort for the passengers as well as unwanted dynamic forces in the mechanisms for opening/closing the front doors of the aircraft. It could therefore be beneficial to find a solution to reduce this transitory vibratory phenomenon.

### SUMMARY

An object of the disclosure herein is a solution for attenuating the aforementioned transitory vibratory phenomenon. It concerns a set of doors for a front landing gear bay of an aircraft including two front doors and two rear doors intended to open and to close the front landing gear bay to enable lowering or retraction of a landing gear.

According to the disclosure herein each of the front doors is fitted with at least one deflector arranged on an internal face of the front door near a rear leading edge thereof, the deflector extending at least partially along the rear leading edge.

Thus, thanks to the deflectors of the front doors, a solution is available enabling action on an aerodynamic flow between the front doors when they are open. In particular, this solution enables action on the aerodynamic flow in such a manner as significantly to attenuate undesirable vibratory phenomena that can arise in the particular configuration in which the front doors are open and the rear doors are closed.

Each of the deflectors is advantageously arranged on the internal face of the corresponding front door at a distance from its rear leading edge that is less than 20% of a total length of the front door.

Moreover, each of the deflectors advantageously includes a plate having a deflector surface.

In an embodiment, the plate of each of the deflectors has a length between 30% and 50% inclusive of a width of the front door on which the deflector is arranged.

Moreover, the plate of each of the deflectors advantageously has a height between 50 mm and 150 mm inclusive.

Additionally, the plate of each of the deflectors advantageously has a substantially plane shape at an angle to a direction orthogonal to the internal face of the front door on which the deflector is arranged, the angle being in a defined angular range between 0° and 5° inclusive, such that:
0° corresponds to a position in which the plate is parallel to the orthogonal direction; and
5° corresponds to a position in which the plate is inclined toward the rear leading edge of the front door forming an angle of 5° with the orthogonal direction.

Moreover, in an embodiment, each of the deflectors includes a plurality of fixing lugs, each of the fixing lugs being adapted to be fixed to the internal face of the front door on which the deflector is arranged.

Moreover, each of the deflectors is advantageously fixed to the front door by at least one of the following fixing elements: rivet, screw, bolt, glue.

The disclosure herein also concerns a front landing gear bay for an aircraft, the front landing gear bay including a cavity adapted to receive a landing gear, an opening configured for the passage of the landing gear, and a set of doors adapted to open and to close the opening to enable lowering or retraction of the landing gear. According to the disclosure herein, the set of doors of the front landing gear bay corresponds to the set of doors described hereinabove.

The disclosure herein further concerns an aircraft that includes a front landing gear bay as described hereinabove.

### BRIEF DESCRIPTION OF THE DRAWINGS

The appended figures will provide a clear understanding of how the disclosure herein may be reproduced in practice. In these figures identical reference numbers designate similar elements.

FIG. 1 is a perspective view of an embodiment of an aircraft including a front landing gear bay fitted with a set of doors comprising front doors fitted with deflectors.

FIG. 2 is a perspective view to a larger scale of the front landing gear bay of the aircraft from FIG. 1.

FIG. 3 is a perspective view of a front door of the set of doors of the aircraft from FIG. 1 in an open position.

FIG. 4 is a partial perspective view of a front door that is part of an embodiment of a set of doors.

FIG. 5 is a schematic view of an embodiment of a set of doors including front doors fitted with inclined deflectors.

### DETAILED DESCRIPTION

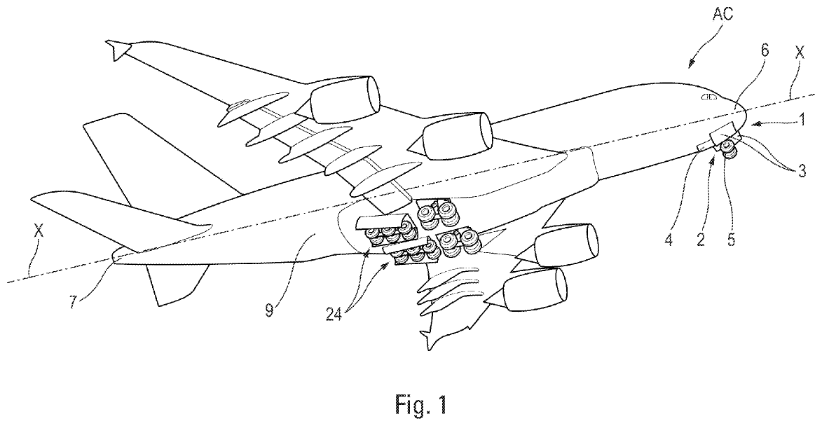

The set of doors (hereinafter set 1) illustrating the disclosure herein and represented in particular embodiments from FIG. 1 to FIG. 5 is intended to be mounted on a front landing gear bay 2 of an aircraft AC, in particular a transport aircraft.

By “set of doors” is meant elements enabling opening and closing of the front landing gear bay 2 and comprising doors as well as standard means and members for opening or closing those doors.

As represented in FIG. 1, the aircraft AC comprises a nose 6 at the front and a tail 7 at the rear and is provided on a lower part of a fuselage 9 with rear landing gears 24 and a front landing gear 5 that are retractable. The rear landing gears 24 are situated at the level of a central part of the aircraft AC while the front landing gear 5 is situated near the nose 6.

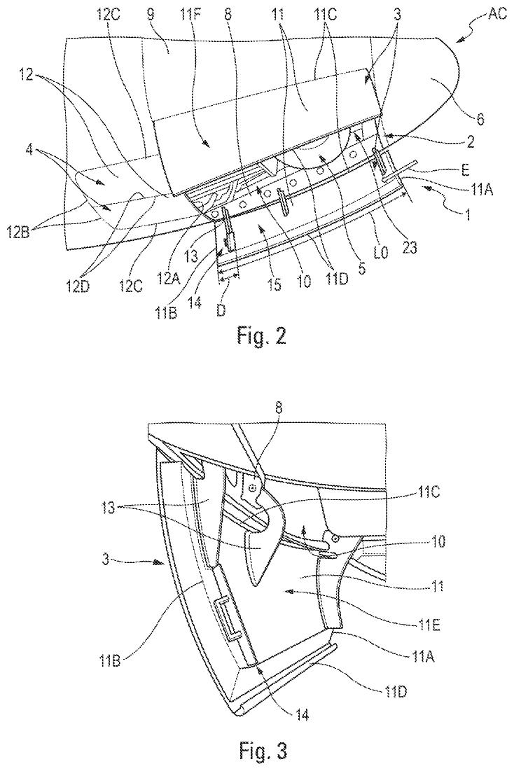

As represented in FIG. 2, the set 1 includes two front doors 3 and two rear doors 4 intended to open and to close the front landing gear bay 2 in order to lower or to retract the front landing gear 5 of the aircraft AC. The set 1 is mounted on a structure 8 of the fuselage 9 of the aircraft AC at the level of an opening 10 of the front landing gear bay 2 situated on a lower part of the fuselage 9. The front landing gear bay 2 contains in particular the landing gear 5, which is provided with standard systems (not represented) enabling it to be unfolded (lowered) or folded (retracted) through the opening 10.

In the context of the present description:
by “front” is meant that which is situated or oriented toward the front of the aircraft AC, that is to say toward the nose 6;
by “rear” is meant that which is situated or oriented toward the rear of the aircraft, that is to say toward the tail 7;
by “internal” or “interior” is meant that which is situated or oriented toward the space of the aircraft AC delimited by the fuselage 9;
by “external” or “exterior” is meant that which is situated or oriented outside the space of the aircraft AC delimited by the fuselage 9;
by “lateral” or “laterally” is meant that which is situated or oriented transversely on either side of a vertical plane of symmetry of the aircraft AC;
by “upper” is meant that which is situated toward the top of the aircraft AC; and
by “lower” is meant that which is situated toward the belly of aircraft AC. Moreover, in the context of the disclosure herein:
“landing gear” designates an assembly including a strut provided with one or more wheels as well as other systems, for example shock absorbing systems, guide systems, brake systems and/or retraction systems; and
“front landing gear bay” designates a housing situated in the lower part of the fuselage 9 of the aircraft AC at the front (near the nose 6) and that is intended to receive the front landing gear 5.

Moreover, as represented in FIG. 2, each of the front doors 3 includes a panel 11 and each of the rear doors 4 includes a panel 12. The panels 11 and 12 have a substantially rectangular shape.

As represented in FIG. 2 and FIG. 5, each of the panels 11 of the two front doors 3 has:
a front leading edge 11A situated at a front end of the corresponding front door 3;
a rear leading edge 11B situated at a rear end of the corresponding front door 3 opposite the front leading edge 11A;
a lateral edge 11C situated at a lateral edge of the corresponding front door 3;
a free lateral edge 11D situated at a free lateral edge of the corresponding front door 3 opposite the lateral edge 11C;
an internal face 11E; and
an external face 11F opposite the internal face 11E.

Likewise, as also represented in FIG. 2 and FIG. 5, each of the panels 12 of the two rear doors 4 has:
a front leading edge 12A situated at a front end of the corresponding rear door 4;
a rear leading edge 12B situated at a rear end of the corresponding rear door 4 opposite the front leading edge 12A;
a lateral edge 12C situated at a lateral edge of the corresponding rear door 4;
a free lateral edge 12D situated at a free lateral edge of the corresponding rear door 4 opposite the lateral edge 12C;
an internal face 12E; and
an external face 12F opposite the internal face 12E.

In a preferred embodiment represented in FIG. 2, the front doors 3 and the rear doors 4 of the set 1 are connected to the structure 8 of the fuselage 9 of the aircraft AC by articulation elements 13. These articulation elements 13 are adapted to cause the front doors 3 and the rear doors 4 to pivot to open or to close the front landing gear bay 2. They are fixed to the panels 11 of the front doors 3 near each of the lateral edges 11C and are fixed to the panels 12 of the rear doors 4 near each of the lateral edges 12C. The set 1 also includes actuation devices (not represented) adapted to be controlled so as to actuate opening and closing of the front doors 3 and the rear doors 4 in the usual manner.

Each of the pairs of doors is configured so that it can be brought into at least two different positions, namely an open position in which the doors open the part of the opening 10 that they cover and a closed position in which they close the part of the opening 10 as specified hereinafter.

In the closed position, the doors are folded laterally toward the centre of the aircraft AC, namely toward its vertical plane of symmetry. For the front doors 3, the closed position corresponds to a position in which the panels 11 are folded and meet at the level of their lateral edges 11D. Likewise, for the rear doors 4, the closed position corresponds to a position in which the panels 12 are folded and meet at the level of their lateral edges 12D. When the front doors 3 and the rear doors 4 are all in the closed position, their lateral edges 11D and 12D form a continuous and linear central junction in the vertical plane of symmetry of the aircraft AC.

In the open position, the doors are pivoted toward the exterior of the aircraft AC in such a manner as to open the opening 10. For the front doors 3, the open position corresponds to a position of the panels 11 in which their lateral edges 11D are oriented downward (under the aircraft AC) and their internal faces 11E face one another. Likewise, for the rear doors 4, the open position corresponds to a position of the panels 12 in which their lateral edges 12D are oriented downward (under aircraft AC) and their internal faces 12E face one another. When the front doors 3 and the rear doors 4 are all in the open position, they open the opening 10 in such a manner as to allow the landing gear 5 to pass through it.

Moreover, the front doors 3 are aligned with the rear doors 4 in the longitudinal direction of the aircraft AC depicted by a longitudinal axis X-X in FIG. 1. The front doors 3 are directly adjacent to the rear doors 4, and in particular the rear edges 11B of the front doors 3 are adjacent to the front edges 12A of the rear doors 4.

Moreover, the set 1 is configured to cause opening and closing of the front doors 3 and the rear doors 4 in a non-simultaneous manner, namely at different times. Accordingly, during opening and closing of the doors, a particular configuration represented in FIG. 2 and described hereinafter is encountered in which the front doors 3 are in the open position and the rear doors 4 are in the closed position.

Moreover, each of the two front doors 3 of the set 1 is fitted with a deflector 14. These deflectors 14 may have varied shapes and be made of different materials, for example of metal (aluminum) or a composite material.

Each of the deflectors 14 is arranged on the internal face 11E near the rear leading edge 11B and extends along the rear leading edge 11B. Each of the deflectors 14 preferably extends parallel to the rear leading edge 11B of the front door 3 on which it is arranged. However, in other embodiments, the deflectors 14 may have varied orientations relative to the rear leading edge 11B.

The deflectors 14 arranged in this way are able to act on an aerodynamic flow represented by an arrow E in FIG. 2 and FIG. 5, for example a flow of air, flowing in a space 15 between the internal faces 11E of the front doors 3 when they are in the open position.

The arrangement of the deflectors 14 near the rear leading edges 11B enables a surprising effect to be obtained in the particular configuration of FIG. 2 in which the front doors 3 are in the open position and the rear doors 4 are in the closed position. Indeed, this arrangement enables the deflectors 14 to disturb the aerodynamic flow between the front doors 3 in such a manner as significantly to attenuate transitory vibratory phenomena that can arise in this particular configuration. This attenuation of transitory vibratory phenomena can represent a reduction of vibrations of the order of 30%.

Accordingly, thanks to the deflectors 14 of the front doors 3, a simple, lightweight and compact set 1 is obtained enabling significant attenuation of the undesirable vibratory phenomena that can arise in the particular configuration in which the front doors 3 are open and the rear doors 4 are closed. The set 1 is in particular simple to employ and easily adaptable to any type of door. Moreover, it is a passive assembly, the deflectors 14 having no need of energy or to be moved in order to function. Moreover, the set 1 is robust since the front doors 3 on which the deflectors 14 are arranged are part of the primary structure of the aircraft AC.

Moreover, as represented in FIG. 2 and FIG. 5, each of the deflectors 14 is arranged on the internal face 11E of the corresponding front door 3 at a distance D from the rear leading edge 11B. This distance D is preferably less than 20% of a total length L0 of the front door 3. The total length L0 corresponds to the length between the front leading edge 11A and the rear leading edge 11B.

The distance D at which the deflectors 14 are arranged from the rear edges 11B of the front doors 3 can in particular enable variation of the manner in which the deflectors 14 act on the aerodynamic flow flowing between the front doors 3.

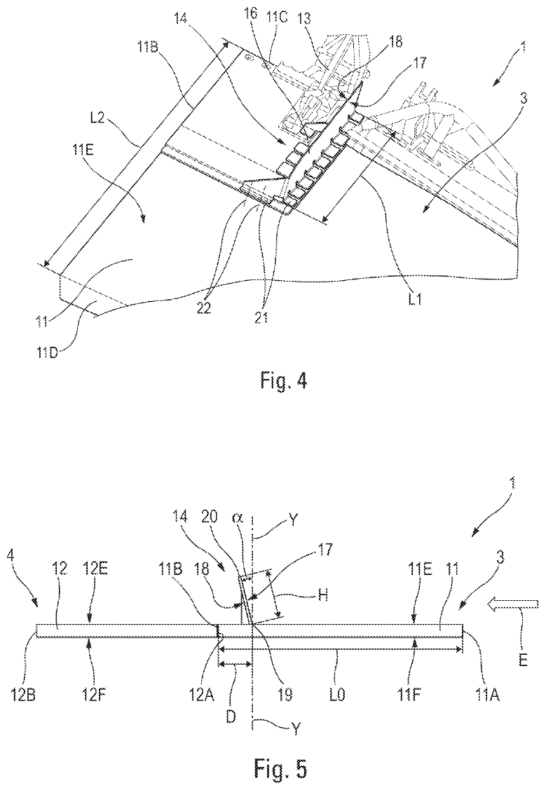

In an embodiment represented in FIG. 4, each of the deflectors 14 includes a plate 16 fixed to the corresponding front door 3 orthogonally to the internal face 11E. Each of the plates 16 has a deflector face 17 oriented toward the front leading edge 11A of the front door 3 and a rear face 18 (FIG. 5) oriented toward the rear leading edge 11B.

The plate 16 is preferably plane, that is to say the deflector face 17 and the rear face 18 are parallel. However, in particular embodiments, the plate 16 may have varied shapes, for example with a curved deflector face 17.

Moreover, as represented in FIG. 5, the plate 16 has an edge 19 between the internal face 11E of the front door 3 and a free edge 20 opposite the edge 19. It has in particular a rectangular shape having a length L1 (FIG. 4) and a height H. The height H corresponds to the distance between the edges 19 and 20. The height H is preferably between 50 mm and 150 mm inclusive. Such a height H enables the required effect on the aerodynamic flow between the front doors 3 to be obtained while avoiding generating high drag.

In an implementation of the previous embodiment, not represented in FIG. 4, the plate 16 of each of the deflectors 14 has a length L1 extending over a part of a width L2 of the front door 3 on which it is arranged. The width L2 corresponds to the distance between the lateral edge 11C and the free lateral edge 11D. The length L1 is preferably between 30% and 50% inclusive of the width L2.

The length L1 and the height H of the plates 16 may in particular enable variation of the manner in which the deflectors 14 act on the aerodynamic flow flowing between the front doors 3.

In another particular implementation of the previous embodiment, represented schematically in FIG. 5, the plate of each of the deflectors 14 has a substantially plane shape, is arranged along the rear leading edge 11B and forms an angle α with a direction orthogonal to the internal face 11E of the front door 3, illustrated by an axis Y-Y.

The angle α is preferably in a defined angular range between 0° and 5°. An angle of 0° corresponds to a position in which the plate 16 is parallel to the direction orthogonal to the internal face 11E (as in the FIG. 4 example). Moreover, an angle of 5° corresponds to a position in which the plate 16 is inclined toward to the rear leading edge 11B of the front door 3, at an angle of 5° to the direction (axis Y-Y) orthogonal to the internal face 11E, as represented in FIG. 5.

The inclination of the plates 16 can in particular enable variation of the manner in which the deflectors 14 act on the aerodynamic flow flowing between the front doors 3.

Moreover, as represented in FIG. 4, in an embodiment, each of the deflectors 14 includes a plurality of fixing lugs 21 enabling the deflector 14 to be fixed to the corresponding front door 3. The fixing lugs 21 have two different shapes. Some fixing lugs 21 have a tongue shape extending on either side of the deflector 14 at the level of the edge 19. These tongues are pressed onto the internal face 11E of the front door 3. Other fixing lugs 21 have a bracket shape extending between the rear face 18 of the deflector 14 and the internal face 11E of the front door 3. These fixing lugs 21 may have varied shapes that can facilitate the arrangement of the deflectors 14 on the front doors 3.

Moreover, each of the deflectors 14 is fixed to the corresponding front door 3 by standard fixing elements 22. These fixing elements 22, represented schematically in FIG. 4, may be rivets, screws, bolts or glue.

As indicated hereinabove the set 1 is configured to open or to close the opening 10 thereof to lower or to retract the front landing gear 5 during landing or take-off of the aircraft AC.

During take-off, the front doors 3 and the rear doors 4 are in the open position. The landing gear 5 is lowered and enables the aircraft AC to roll on the ground. When the aircraft AC has left the ground, the landing gear 5 is folded and retracted into the cavity 23 by an appropriate actuation mechanism (not represented). This actuation mechanism is coupled to the rear doors 4 in such a manner as to drive them into the closed position at the same time as retracting the landing gear 5. When the landing gear 5 is folded and the rear doors 4 are closed, or during closing thereof, the set 1 is configured to actuate the closing of the front doors 3. When the front doors 3 are brought into the closed position, the front landing gear bay 2 is closed.

Moreover, during landing, the front doors 3 and the rear doors 4 are, firstly, in the closed position and the landing gear 5 is folded into the front landing gear bay 2. The set 1 is configured thereafter to open the opening 10 of the front landing gear bay 2 by initially actuating only opening of the front doors 3 while the rear doors 4 remain in the closed position. When the front doors 3 are in the open position, or during opening thereof, the actuation mechanism of the landing gear 5 is commanded to unfold it. This actuation mechanism is coupled to the rear doors 4 in such a manner as to cause them to open at the same time as the landing gear 5 is lowered. When the landing gear 5 has been lowered, all the doors of the set 1 are in the open position and the aircraft AC can land.

During landing and during take-off of the aircraft AC, during a time interval of the order of a few seconds, generally between 5 and 10 seconds, the set 1 is therefore in the particular configuration in which the front doors 3 are open and the rear doors 4 are closed. As specified hereinabove in the description, in this particular configuration vibratory phenomena can arise at the level of the front landing gear bay 2.

These vibratory phenomena are linked to the flow of air, in particular in the space 15 between the front doors 3 in the open position, which penetrates into the partially closed front landing gear bay 2 via the rear doors 4. These vibratory phenomena are transitory because they arise only during this time interval between opening (or closing) the front doors 3 and opening (or closing) the rear doors 4.

Thanks to the deflectors 14 of the set 1, these transitory vibratory phenomena are significantly attenuated. Indeed, the deflectors 14 enable action on the flow of air between the front doors 3. To be more precise, they enable the flow of air to be disturbed, for example by preventing a portion of the flow of air from penetrating into the cavity 23 of the front landing gear bay 2. This has the effect of reducing the vibrations that may be generated at the level of the front landing gear bay 2.

The set 1 of doors as described hereinabove and intended to be mounted on the front landing gear bay 2 of the aircraft AC has numerous advantages. In particular:
it enables an aerodynamic flow flowing between the front doors 3 to be disturbed in such a manner as to attenuate transitory vibratory phenomena at the level of the front landing gear bay 2 when the front doors 3 are in the open position and the rear doors 4 are in the closed position;
it enables structural resonance of the front landing gear bay 2 to be prevented;
it is of passive type, i.e. it necessitates no energy to function;
it is light in weight, compact and of relatively low cost;
its design and installation are simple;
it can easily be mounted on any type and any shape of structure; and
it is arranged on a primary structure of the aircraft AC.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A set of doors for a front landing gear bay of an aircraft, the set of doors including two front doors and two rear doors to open or to close the front landing gear bay to enable lowering or retraction of a landing gear, wherein each of the front doors is fitted with at least one deflector on an internal face of the front door near a rear leading edge thereof, the deflector extending at least partially along the rear leading edge.

2. The set according to claim 1, wherein each of the deflectors is on the internal face of a corresponding front door at a distance from its rear leading edge that is less than 20% of a total length of the front door.

3. The set according to claim 1, wherein each of the deflectors includes a plate having a deflector surface.

4. The set according to claim 3, wherein the plate of each of the deflectors has a length between 30% and 50% inclusive of a width of the front door on which the deflector is arranged.

5. The set according to claim 3, wherein the plate of each of the deflectors has a height between 50 mm and 150 mm inclusive.

6. The set according to claim 3, wherein the plate of each of the deflectors has a substantially plane shape at an angle to a direction orthogonal to the internal face of the front door on which the deflector is arranged, the angle being in a defined angular range between 0° and 5° inclusive, such that:
0° corresponds to a position in which the plate is parallel to the orthogonal direction (Y-Y); and
5° corresponds to a position in which the plate is inclined toward the rear leading edge of the front door forming an angle of 5° with the orthogonal direction.

7. The set according to claim 1, wherein each of the deflectors includes a plurality of fixing lugs, each of the fixing lugs being configured to be fixed to the internal face of the front door on which the deflector is arranged.

8. The set according to claim 1, wherein each of the deflectors is fixed to the front door by at least one of a rivet, screw, bolt, glue.

9. A front landing gear bay for an aircraft, the front landing gear bay including a cavity to receive a landing gear, an opening configured for passage of the landing gear, and a set of doors to open and to close the opening to enable lowering or retraction of the landing gear, wherein the set of doors corresponds to the set according to claim 1.

10. An aircraft comprising a front landing gear bay according to claim 9.
